(19) United States
(12) Patent Application Publication
(10) Pub. No.: US 2025/0220454 A1
(43) Pub. Date: Jul. 3, 2025

(54) DYNAMIC JOINT PERFORMANCE AND COMPLEXITY OPTIMIZATION OF A RECEIVER

(71) Applicants: Thushara Hewavithana, Tempe, AZ (US); Nicholas Whinnett, Bath (GB); Jan Schreck, San Jose, CA (US); Yang-Seok Choi, Portland, OR (US); Peng Lu, Elk Grove, CA (US); Xiaofeng Li, San Jose, CA (US); Yuzhou Zhang, San Diego, CA (US); Michael Beadle, Tustin, CA (US); Neelam Chandwani, Portland, OR (US); Ranjit Cavatur, Laguna Niguel, CA (US)

(72) Inventors: Thushara Hewavithana, Tempe, AZ (US); Nicholas Whinnett, Bath (GB); Jan Schreck, San Jose, CA (US); Yang-Seok Choi, Portland, OR (US); Peng Lu, Elk Grove, CA (US); Xiaofeng Li, San Jose, CA (US); Yuzhou Zhang, San Diego, CA (US); Michael Beadle, Tustin, CA (US); Neelam Chandwani, Portland, OR (US); Ranjit Cavatur, Laguna Niguel, CA (US)

(21) Appl. No.: 18/397,185

(22) Filed: Dec. 27, 2023

(51) Int. Cl. H04W 24/02; H04L 41/16

(52) U.S. Cl. CPC H04W 24/02; H04L 41/16

(57) ABSTRACT

Equipment for controlling a node in a wireless communication system can include a processor. The processor can identify scenarios under which at least one wireless communication system problem can occur, and metrics that characterize the scenarios. Based on the metrics the processor can generate a set of sub-problems, where a sub-problem of the set can correspond to a respective scenario. The processor can identify a set of algorithms for responding to respective sub-problems of the set of sub-problems to generate a module. The processor can provide control logic to determine which algorithm of the module to execute during operation of the wireless communication system based on detection of problems of an identified scenario. The processor can provide identification of a selected algorithm based on the determining. Communication circuitry can provide identification of the selected algorithm for execution within the wireless communication system.

### TECHNICAL FIELD

Aspects pertain to wireless communications. Some aspects relate to software implementation of baseband processing.

### BACKGROUND

In most radio access network (RAN) devices, baseband processing is implemented with purpose designed hardware, and each module is dimensioned and designed for the worst-case scenario (or acceptable performance for every scenario). There is no benefit in designing multiple algorithms for the same module (it takes more HW resources). In contrast, virtual RAN allows some functions to be implemented in software that can be customized more easily for different scenarios.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network in which some aspects of the disclosure may be implemented.

FIG. 1B illustrates a non-roaming 5G system architecture in accordance with some aspects.

FIG. 2 illustrates an example of an Open RAN (O-RAN) system architecture in which some aspects of the disclosure may be implemented.

FIG. 3 illustrates a logical architecture of the O-RAN system of FIG. 2, in accordance with some aspects.

FIG. 4 is a system level block diagram of O-RAN radio unit (RU) and distributed unit (DU) to illustrate different domains of optimization according to some aspects.

FIG. 5 illustrates module architecture in accordance with some aspects.

FIG. 6 illustrates module optimization architecture in accordance with some aspects.

FIG. 7 illustrates multiple input multiple output (MIMO) equalization using an equalization control module according to some aspects.

FIG. 8 is a flow diagram illustrating method for communicating application data from a first user device to a second user device, in accordance with some aspects.

FIG. 9 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

### Systems and Networks

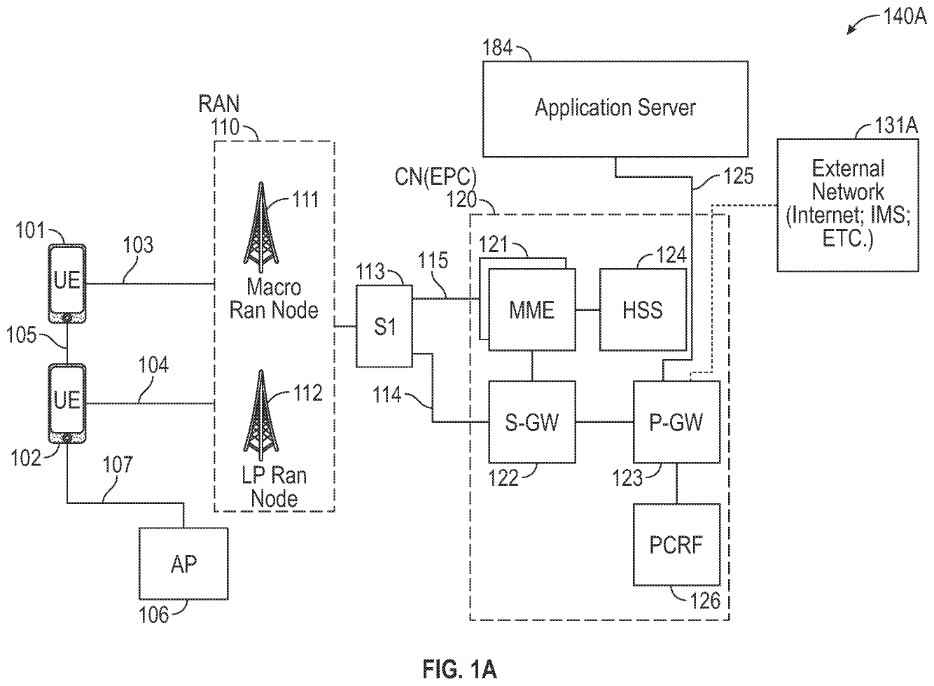

FIG. 1A illustrates an architecture of a network in which some aspects of the disclosure may be implemented. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein. Any of the radio links described herein (e.g., as used in the network 140A or any other illustrated network) may operate according to any exemplary radio communication technology and/or standard. FIG. 1B illustrates a non-roaming 5G system architecture in accordance with some aspects and is described in more detail later herein.

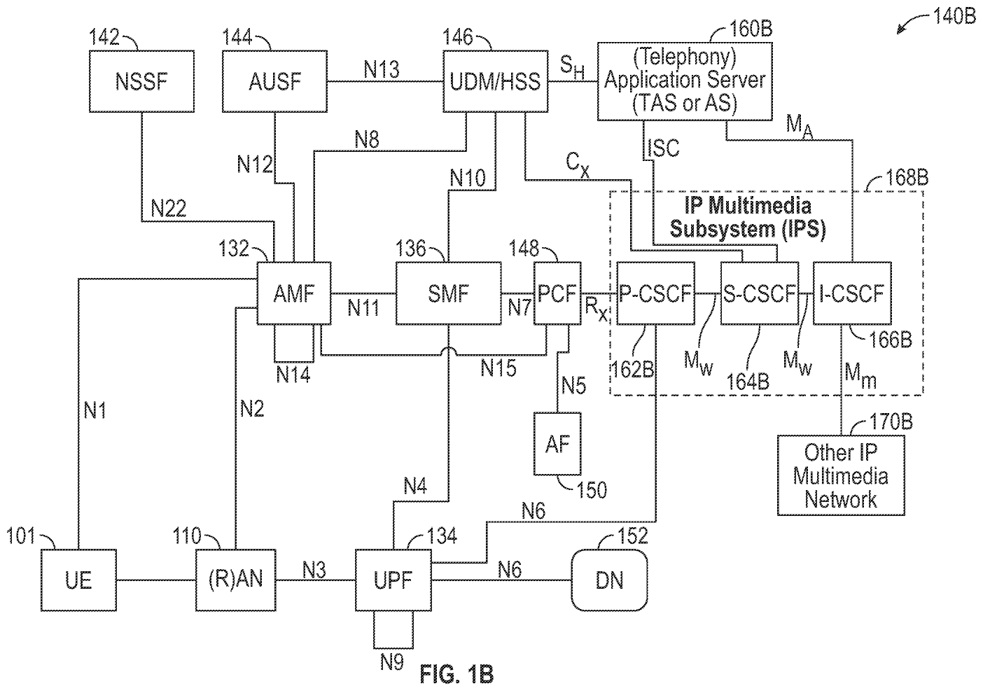

Referring now to FIG. 2, FIG. 2 provides a high-level view of an Open RAN (O-RAN) architecture 200, which can also be referred to as virtualized RAN (V-RAN). The O-RAN architecture 200 includes four O-RAN defined interfaces—namely, the A1 interface, the O1 interface, the O2 interface, and the Open Fronthaul Management (M)-plane interface—which connect the Service Management and Orchestration (SMO) framework 202 to O-RAN network functions (NFs) 204 and the O-Cloud 206. The SMO 202 also connects with an external system 210, which provides additional configuration data to the SMO 202. FIG. 2 also illustrates that the A1 interface connects the O-RAN Non-Real Time (RT) RAN Intelligent Controller (RIC) 212 in or at the SMO 202 and the O-RAN Near-RT RIC 214 in or at the O-RAN NFs 204. The O-RAN NFs 204 can be virtualized network functions (VNFs) such as virtual machines (VMs) or containers, sitting above the O-Cloud 206 and/or Physical Network Functions (PNFs) utilizing customized hardware. All O-RAN NFs 204 are expected to support the O1 interface when interfacing with the SMO framework 202. The O-RAN NFs 204 connect to the NG-Core 208 via the NG interface (which is a 3GPP-defined interface). The Open Fronthaul M-plane interface between the O-RAN Distributed Unit (DU) and the O-RAN Radio Unit (O-RU) 216 supports the O-RU 216 management in the O-RAN hybrid model. The O-RU's termination of the Open Fronthaul M-plane interface is an optional interface to the SMO 202 that is included for backward compatibility purposes and is intended for management of the O-RU 216 in hybrid mode only. The O-RU 216 termination of the O1 interface towards the SMO 202 is specified in ORAN standards.

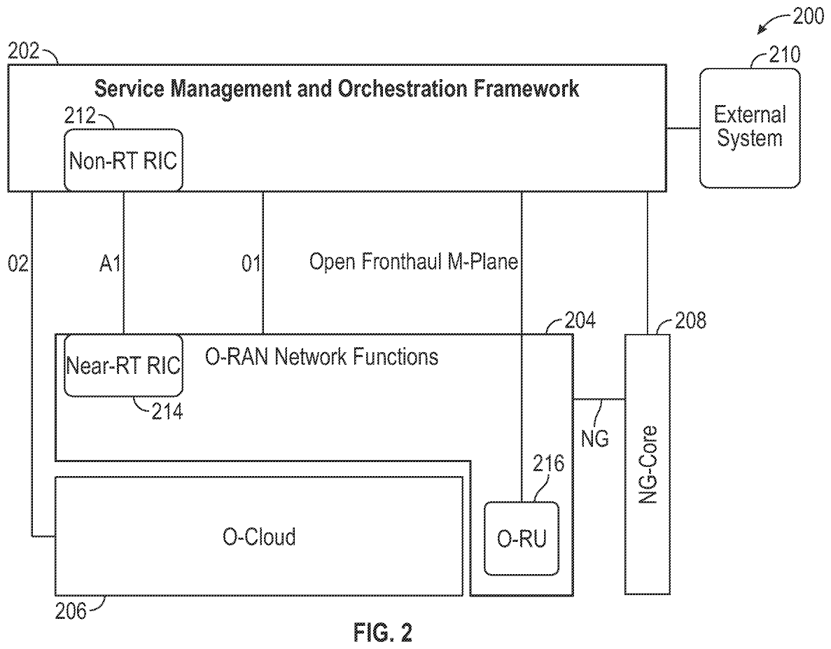

FIG. 3 shows an O-RAN logical architecture 300 corresponding to the O-RAN architecture 200 of FIG. 2. In FIG. 3, the SMO 302 corresponds to the SMO 202, O-Cloud 306 corresponds to the O-Cloud 206, the non-RT RIC 312 corresponds to the non-RT RIC 212, the near-RT RIC 314 corresponds to the near-RT RIC 214, and the O-RU 316 corresponds to the O-RU 216 of FIG. 2, respectively. The O-RAN logical architecture 300 includes a radio portion and a management portion.

The management portion/side of the architecture 300 includes the SMO Framework 302 containing the non-RT RIC 312 and may include the O-Cloud 306. The O-Cloud 306 is a cloud computing platform including a collection of physical infrastructure nodes to host the relevant O-RAN functions (e.g., the near-RT RIC 314, O-RAN Central Unit-Control Plane (O-CU-CP) 321, O-RAN Central Unit-User Plane (O-CU-UP) 322, and the O-RAN Distributed Unit (O-DU) 315), supporting software components (e.g., OSs, VMs, container runtime engines, ML engines, etc.), and appropriate management and orchestration functions.

The radio portion/side of the logical architecture 300 includes the near-RT RIC 314, the O-RAN Distributed Unit (O-DU) 315, the O-RU 316, the O-RAN Central Unit-Control Plane (O-CU-CP) 321, and the O-RAN Central Unit-User Plane (O-CU-UP) 322 functions. The radio portion/side of the logical architecture 300 may also include the O-e/gNB 310.

The O-DU 315 is a logical node hosting RLC, MAC, and higher PHY layer entities/elements (High-PHY layers) based on a lower-layer functional split. The O-RU 316 is a logical node hosting lower PHY layer entities/elements (Low-PHY layer) (e.g., FFT/iFFT, PRACH extraction, etc.) and RF processing elements based on a lower layer functional split. The O-CU-CP 321 is a logical node hosting the RRC and the control plane (CP) part of the PDCP protocol. The O O-CU-UP 322 is a logical node hosting the user-plane part of the PDCP protocol and the SDAP protocol.

### Dynamic Joint Performance and Complexity Optimization

As briefly described earlier herein, in RAN devices in use today, baseband processing is implemented with purpose designed hardware, and each module must be dimensioned and designed for the worst-case scenario (or acceptable performance for every scenario). There is no benefit in designing multiple algorithms for the same module as this consumes more hardware resources. In contrast, for virtual RAN (v-RAN), for example in some systems described above with reference to FIG. 1A-FIG. 3, where baseband Layer 1, and Layer 2 processing is implemented in software, aspects according to this disclosure can provide joint optimization of a system (Layer 1 and 2) and optimization of key performance indicators (KPIs) including for example wireless performance, complexity (core count), latency, etc.

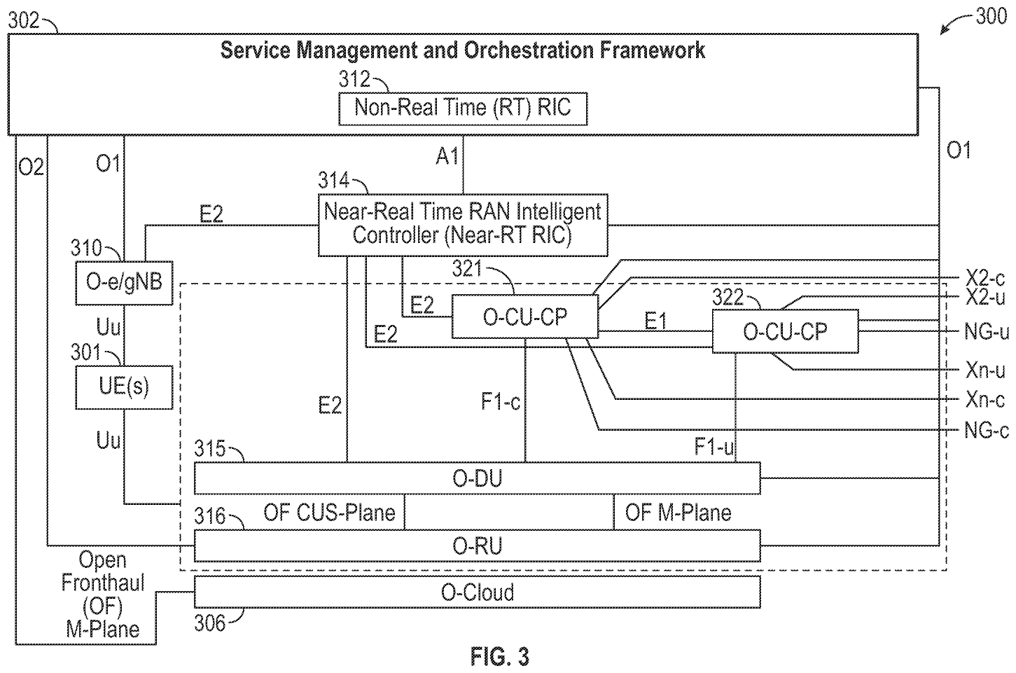

In ORAN architecture, Layer 1 upper PHY and Layer 2 are implemented in a DU (see e.g., FIG. 2 and FIG. 3). The DU is connected to RU via a fronthaul connection (fiber) as also shown in FIGS. 2-3. FIG. 4 is a system level block diagram of O-RAN radio unit (RU) and distributed unit (DU) to illustrate different domains 402, 404, 406, 408 of optimization according to some aspects of the disclosure. Other components shown in FIG. 4 are described in detail with reference to FIGS. 1A-3.

In fronthaul domain 402, signal dimensions can be optimized to reduce fronthaul throughput as well as lower the achievable complexity for a DU (this sets a lower bound). Beamforming algorithms may be used for optimization of domain 402. For example, data going from RU 403 will be provided within a pipeline, which is to be decoded at the DU. Because multiple input-multiple output (MIMO) antenna systems are typically used in such systems, very large amounts of data and a large number of data streams may need to be decoded. Beamforming optimizations can reduce this complexity, for example the number of streams provided can be reduced for t64, e.g., to a smaller number such as 16 or fewer using beamforming 404.

In Layer 1 domain 404, module level and pipeline optimization can be performed as described later herein. In Layer 2 domain 406 optimization, module level and overall L2 optimization can be performed.

In Layer 1 (L1) and Layer 2 (L2) domain 408 joint optimizations can be performed, for example a beamforming aware scheduler can be implemented. To optimize in domain 408 an inter-layer dependent optimization problem is solved in a systematic approach using a proposed DU architecture and algorithm methodology. Optimizations described herein will typically be provided within a DU because the DU implements L1 and L2. Algorithms can be executed as software within the DU itself or can be provided in a near real-time (RT) RAN intelligent controller (RIC) as is presented with respect to other figures described later herein.

Aspects of the present disclosure are based upon observations regarding radio communications, RAN, and V-RAN. For example, for almost all modules in an L1-L2 pipeline, no one algorithm can solve all use cases or scenarios with reasonable complexity. There are many scenarios that can be solved with simpler algorithms where some worst-case scenarios, that are less probable, needs more complex algorithms. The different scenarios impacting algorithm choice can be characterized by a finite number of metrics. For example, a Doppler estimate of UEs can be used to characterize mobile and static scenarios, and interference to noise ratio (INR) can be used to characterize whether a scenario is noise dominated or interference dominated.

Some system configuration parameters, such as the number of receiver antennas, number of layers in the MIMO configuration, etc. can impact algorithm choice. The value of certain key metrics (mentioned above) and configuration parameters can be used to determine the optimal settings (which can be used as parameters for selected algorithms. For example, Doppler estimates can be used to set the optimal settings for time interpolation in channel estimate. The factors or metrics that determines the algorithm choice and parameters that needs to be set for optimal operation of selected algorithms have overlap between different modules.

The above observations allow aspects of this disclosure to optimize algorithm methodology as described herein. Algorithm optimization can provide a design that works for most scenarios with the flexibility of customization for operation in more rare or complex scenarios. Aspects of this disclosure divide the problem (or network condition, network occurrence, operational challenge, etc.) handled by each algorithm module into a smaller/less complex set of sub-problems based on different scenarios encountered or anticipated in field deployment. After such dividing, each sub-problem can be solved with a customized algorithm for that scenario. For most scenarios, a simple algorithm may suffice. Complex algorithms maybe required for certain scenarios. This group of algorithms can form a suite of different algorithms for solving the same problem under different conditions. Because solutions are implemented in software, configurations can be changed more quickly and with less expense.

Control logic implemented internal to the DU (or near RT RIC for example) or can perform algorithm switching and parameter setting. The control module, regardless of which actual device implements aspects of the disclosure, will use key metrics that have been defined based on domain knowledge to reduce or minimize to the number of key metrics that can characterize the scenarios, such that the scenarios can be identified with these metrics alone. Control logic uses the key parameters and key metrics to decide which algorithms to execute and to provide input parameters to those algorithms for execution during scenarios. Combining this methodology with modular design can enable the optimization of individual modules and as well as the joint optimization between the modules (overall system level optimization). This may involve selecting an algorithm within each module (from the suit of algorithms in each module), and also setting optimal parameters for the selected algorithms.

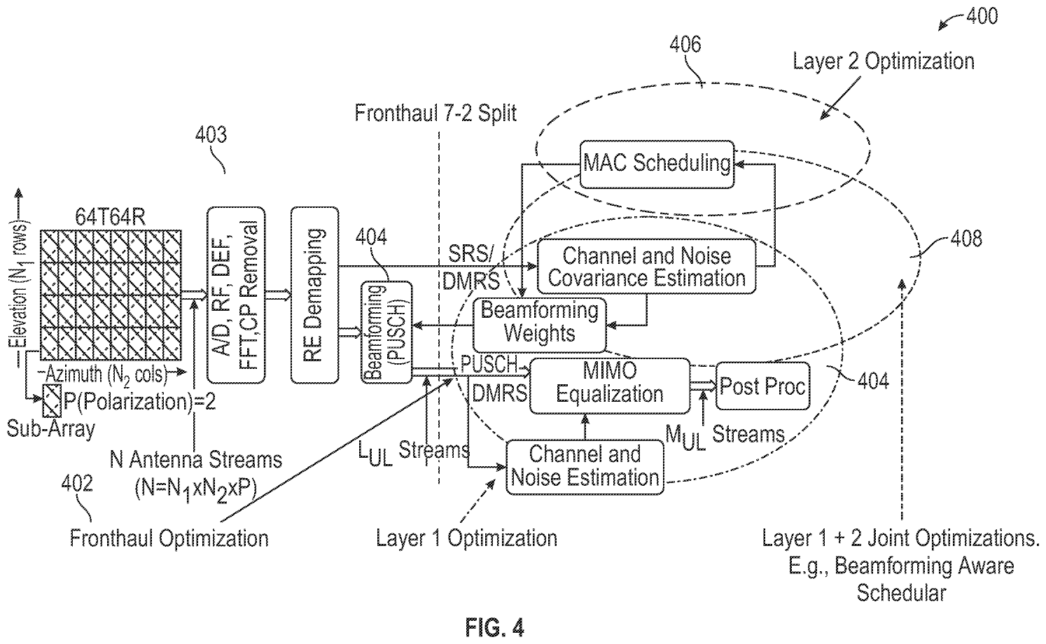

FIG. 5 illustrates module architecture 500 in accordance with some aspects. A module 506 can contain multiple algorithm implementations 508, 510, 512, 514. While four algorithm implementations 508, 510, 512, 514 are shown any number of implementations or different algorithms can be provided. In the example, implementations 510, 512 are of a same algorithm but with different precision or other characteristics. For example, implementation 510 can have 32 bit floating point (fp32) while implementation 512 can have 16 bit floating point (fp16) precision).

Each algorithm can be artificial intelligence (AI) or machine learning (ML) algorithm or a classical algorithm as needed for a particular scenario. Control logic can also be AI/ML-based. If AI/ML based, a control module can be trained using supervised learning, unsupervised learning, online learning, reinforcement learning or any other form of data-driven learning. Ultimately, an AI/ML training technique can be selected for each module depending on many factors including but not limited to the availability of training data, latency constraints, and problem complexity.

To perform supervised training of, for example, an equalization (EQ) control module, it is assumed for illustration that two EQ algorithms are available. In example algorithm A, a simple equalizer can be computed with minimal computational complexity and performs well if interference is low. In example algorithm B, a more sophisticated algorithm is provided that requires significantly more computational complexity but performs well in any interference scenario. To reduce the total computational complexity of the EQ module, the control module needs to select Algorithm A whenever it performs well and select Algorithm B only if it gives a sufficient performance benefit.

For supervised training, a data set is collected with at least a minimum number of samples. Each data sample contains the performance indicators for Algorithm A and B as well as any inputs. Each data sample is labeled to indicate the EQ algorithm that optimally balances performance and complexity. Next, standard techniques are used to train a classifier that based on the available inputs selects an EQ algorithm. The trained classifier is than deployed and its performance is monitored to eventually trigger retraining, if deemed necessary.

Referring still to FIG. 5, the module 506 (or any similar module that can be designed in accordance with aspects of this disclosure) can utilize optimized parameter settings (e.g., parameters 516 provided by control logic or module 518 as described earlier herein). The module 506 (or any similar module that can be designed in accordance with aspects of this disclosure) may contribute measurements 520 to control module 518 to help control module 518 make algorithm switching and parameter optimization decisions.

Measurements can be done by dedicated metric calculation modules 502 that are not part of modules in the data processing pipeline and provided as inputs to the module 506 or control module 518. Input to these modules depend on the metric been calculated. This methodology is applicable to M-MIMO, as well as conventional MIMO, and can be implemented under ORAN 7-2 architecture. Configuration parameters 504 can include L2 configurations, number of antennas, etc. Output 522 can provide a pointer to algorithm/s to select, allow for switching algorithms or sending different parameters, etc. Switching algorithms can depend on measurements captured by dedicated metric calculation modules 502 or other standalone meters, etc. Switching can also be based on configuration parameters 504 provided from L2, for example.

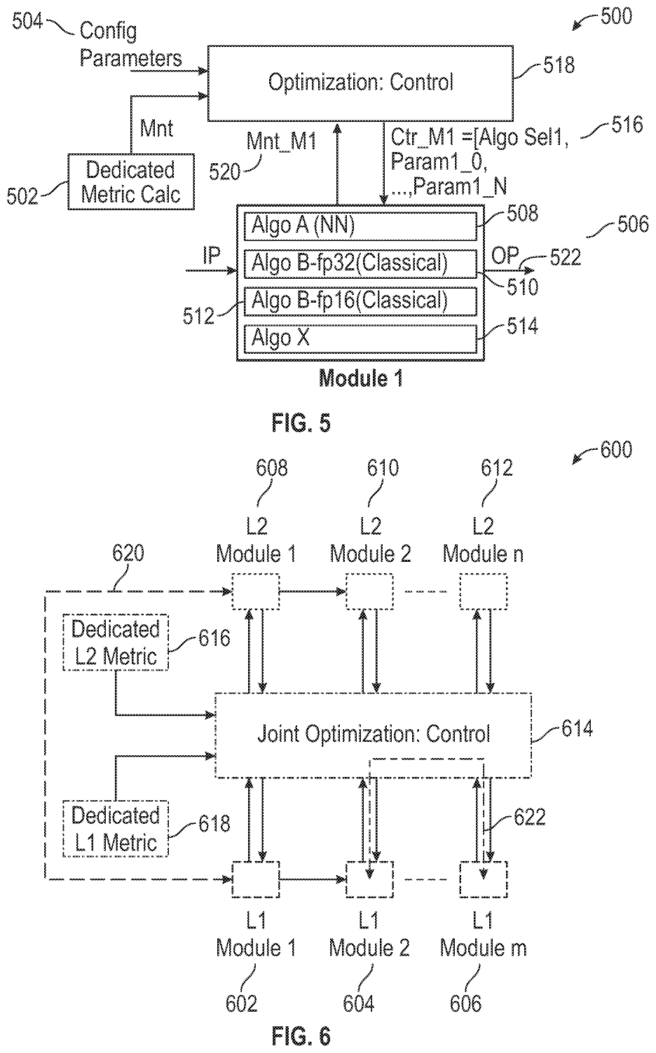

Modules similar to module 500 can be combined with other modules in architecture 600 shown in FIG. 6. Architecture 600 can perform joint optimization, using a common control module to optimize all modules.

Modules combined as shown in FIG. 6 can include L1 modules 602, 604, 606, or any number of L1 modules, as well as L2 modules 608, 610, 612 or any number of L2 modules. L1 modules can include channel estimation modules, equalization modules, modules for mitigation of time/frequency offsets, beamforming modules, etc. L2 modules 608., 610, 612 can include modules for schedule, UE pairing, resource allocation, etc.

Measurements needed for decision making by the joint optimization control module 614 can be passed from individual modules 602, 604, 606, 608, 610, 612 via a well-defined interface with the Layer 1 or Layer 2, depending on module location. The architecture 600 can include dedicated modules 616, 618 for measurements (outside of the main data path) to make certain measurements that could influence performance of more than one module (e.g., SNR measurement). Alternatively, a measurement from one module 602, 604, 606, 608, 610, 612 (e.g., signal to noise ratio (SNR) estimates from a Channel estimator module 602, 604, 606,) could influence the algorithm selection and optimization of other modules 602, 604, 606, 608, 610, 612.

Dependency of two or more different modules 602, 604, 606, 608, 610, 612 on the same measurement provides the motivation and ability for joint optimization (as well as measurement aggregation). For example, FIG. 6 shows possible dependency 620 between module 602 and module 608, and a dependency 622 between module 604 and module 606. Cross-layer modules or intra-layer modules can have dependencies and share optimizations. Performance characteristics of both modules against the measurement can be considered to make the jointly optimal algorithm choices for any two or more modules 602, 604, 606, 608, 610, 612. Figure above shows the blue arrow where L1 Module 1 and L2 Module 1 both has dependencies where L1-L2 joint optimization is possible. For example, cross-layer L1 and L2 optimization may include, Beam management, Beamforming aware scheduling, etc.

Similarly, the orange arrow, connecting Module 2 and Module 3, shows two modules with the L1 that has dependencies that can enable within L1 joint optimization of these two modules.

Determining the measurements and the parameters that influence algorithm selection can be based on domain knowledge. Domain knowledge can include delay spread and Doppler estimates for UE channel, SNR, etc. However, the exact relationship between the measurements and parameters and the algorithm choice may not be known. This could be a complex relationship that does not have a theoretical closed form answer. Therefore AI/ML based implementation is well suited for the joint optimization and control module 614. Once the factors that influence performance and algorithm choice are determined, the module 614 can be trained to learn algorithm selection and optimal parameter selection for algorithms based on known AI/ML training methods. Cost functions can also be defined against which performance should be optimized.

Designs according to aspects of this disclosure are modular and scalable. Each module can have an algorithm added to after original module design. Control logic (e.g., module 518) would need updating to use the new algorithm according to any new scenarios for which the new algorithm is determined to be optimal.

Some aspects of this disclosure can be implemented in an xApp in a near-RT RIC of O-RAN compliant network, where an xApp is a software component of the O-RAN architecture that can control and optimize RAN functions and resources. FIG. 3 described earlier herein and in more detail below illustrate O-RAN and use of near-RT RIC. The associated inputs and outputs of Control would be passed over the E2 interface. Means of identifying groups of algorithms for joint optimization would be standardized. This could involve updates to O-RAN spec to allow for specifying L1/L2 algorithm dependencies in form of common metrics impacting more than one algorithm, and how the performance of each algorithm behave as a function of the common parameters.

Procedures, operations, and apparatuses described herein provide a systematic methodology for optimization of software-based receiver implementation. The approach according to aspects of the disclosure is scalable in that more deployments are studied and learned-from, and as new scenarios are encountered, additional algorithms can be developed and provided to the architecture/solution described herein. Optimization can be performed across layers in the receiver (Layer 1 and Layer 2). Different KPIs can be optimized depending on control module design.

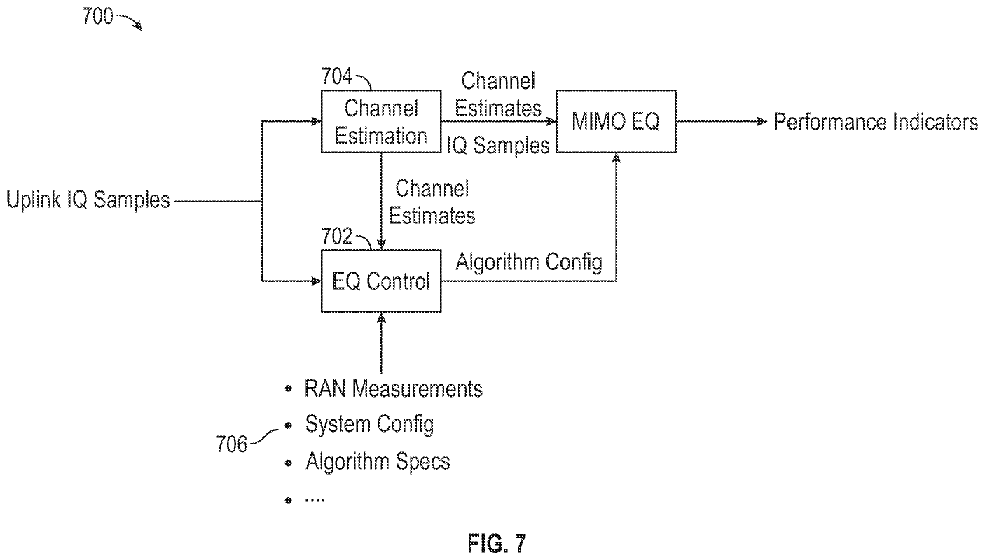

FIG. 7 illustrates multiple input multiple output (MIMO) equalization 700 using an equalization (EQ) control module 702 according to some aspects. The EQ control module 702 can be same or similar to other L1 modules shown in FIG. 4-5.

The EQ control module 702 can obtains measurements from the channel estimation module 704. The EQ control module 702 also has access to the received IQ samples to compute functions of the received IQ samples and channel estimates (e.g., noise plus interference power). Further inputs 706 to the EQ control module 702 may include RAN measurements from other modules (e.g., signal strength measurements, interference measurements), system configurations (e.g., number of scheduled UE's, number of antennas, etc.), algorithm specifications (e.g., algorithm complexity, algorithm execution time, etc.).

Based on available information the EQ control module 702 can select an equalization algorithm for each resource block group (RBG). An RBG can be as small as a few physical resource blocks (12 subcarrier and 14 OFDM symbols).

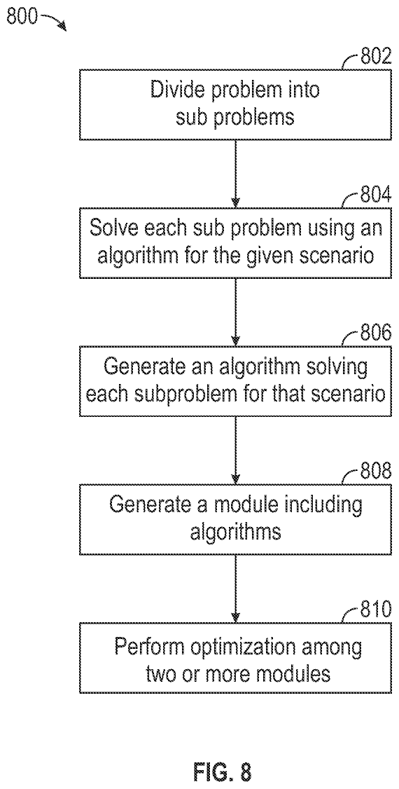

FIG. 8 is a flow diagram illustrating method 800 for communication in a wireless network. Method 800 can be performed by any elements of FIG. 1A-7, and in particular O-Du 315 or Near-ET RIC 314 as described earlier herein.

The method 800 can begin with operation 802 with dividing a problem into sub-problems. As described above, aspects of this disclosure divide an observed problem (or network condition or operational challenge, etc.) handled by each algorithm module into a smaller/less complex set of sub-problems based on different scenarios encountered or anticipated in field deployment.

The method 800 can continue with operation 804 with solving each sub-problem using an algorithm for the given scenario. As described with reference to FIG. 4, and as performed in operation 806, different conditions are observed/measured, and an algorithm can be developed for solving problems associated with those conditions. Sometimes the algorithms will be similar across different problems, but involve variations such as changes in precision, etc.

The method 800 can continue with operation 808 with generating modules comprised of algorithms. Central control modules can be provided to perform optimization 810 and/or selection, based on observed metrics, to select algorithms and provide optimal parameters from across two or more modules, whether in the same area (e.g., within Layer 1, Layer 2, fronthaul, etc.) or in different areas of the network.

### Other Apparatuses and Description of Interfaces and Communications

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Referring again to FIG. 1A, the UEs 101 and 102 may be configured to connect, e.g., communicatively couple, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIG. 1B). In this aspect, the S1 interface 113 is split into two parts: the S1-U interface 114, which carries user traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a primary node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server 160B, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

Referring again to FIG. 3, an E2 interface terminates at a plurality of E2 nodes. The E2 nodes are logical nodes/entities that terminate the E2 interface. For NR/5G access, the E2 nodes include the O-CU-CP 321, O-CU-UP 322, O-DU 315, or any combination of elements. For E-UTRA access the E2 nodes include the O-e/gNB 310. As shown in FIG. 3, the E2 interface also connects the O-e/gNB 310 to the Near-RT RIC 314. The protocols over the E2 interface are based exclusively on Control Plane (CP) protocols. The E2 functions are grouped into the following categories: (a) near-RT RIC 314 services (REPORT, INSERT, CONTROL, and POLICY, as described in O-RAN standards); and (b) near-RT RIC 314 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 3 shows the Uu interface between UE 301 and O-e/gNB 310 as well as between the UE 301 and O-RAN components. The Uu interface is a 3GPP-defined interface, which includes a complete protocol stack from L1 to L3 and terminates in the NG-RAN or E-UTRAN. The O-e/gNB 310 is an LTE eNB, a 5G gNB, or ng-eNB that supports the E2 interface. The O-e/gNB 310 may be the same or similar to other RAN nodes discussed previously. The UE 301 may correspond to UEs discussed previously and/or the like. There may be multiple UEs 301 and/or multiple O-e/gNB 310, each of which may be connected to one another via respective Uu interfaces. Although not shown in FIG. 3, the O-e/gNB 310 supports O-DU 315 and O-RU 316 functions with an Open Fronthaul interface between them.

The Open Fronthaul (OF) interface(s) is/are between O-DU 315 and O-RU 316 functions. The OF interface(s) includes the Control User Synchronization (CUS) Plane and Management (M) Plane. FIG. 2 and FIG. 3 also show that the O-RU 316 terminates the OF M-Plane interface towards the O-DU 315 and optionally towards the SMO 302. The O-RU 316 terminates the OF CUS-Plane interface towards the O-DU 315 and the SMO 302.

The F1-c interface connects the O-CU-CP 321 with the O-DU 315. As defined by 3GPP, the F1-c interface is between the gNB-CU-CP and gNB-DU nodes. However, for purposes of O-RAN, the F1-c interface is adopted between the O-CU-CP 321 with the O-DU 315 functions while reusing the principles and protocol stack defined by 3GPP and the definition of interoperability profile specifications.

The F1-u interface connects the O-CU-UP 322 with the O-DU 315. As defined by 3GPP, the F1-u interface is between the gNB-CU-UP and gNB-DU nodes. However, for purposes of O-RAN, the F1-u interface is adopted between the O-CU-UP 322 with the O-DU 315 functions while reusing the principles and protocol stack defined by 3GPP and the definition of interoperability profile specifications.

The NG-c interface is defined by 3GPP as an interface between the gNB-CU-CP and the AMF in the 5GC. The NG-c is also referred to as the N2 interface (see [O06]). The NG-u interface is defined by 3GPP, as an interface between the gNB-CU-UP and the UPF in the 5GC. The NG-u interface is referred to as the N3 interface. In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC. In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB. In O-RAN, Xn-c and Xn-u protocol stacks defined by 3GPP are reused and may be adapted for O-RAN purposes.

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as an interface between the O-CU-CP 621 and the O-CU-UP 622 functions.

The O-RAN Non-Real Time (RT) RAN Intelligent Controller (RIC) 312 is a logical function within the SMO framework 202, 302 that enables non-real-time control and optimization of RAN elements and resources; AI/machine learning (ML) workflow(s) including model training, inferences, and updates; and policy-based guidance of applications/features in the Near-RT RIC 314.

In some embodiments, the non-RT RIC 312 is a function that sits within the SMO platform (or SMO framework) 302 in the O-RAN architecture. The primary goal of non-RT RIC is to support intelligent radio resource management for a non-real-time interval (i.e., greater than 500 ms), policy optimization in RAN, and insertion of AI/ML models to near-RT RIC and other RAN functions. The non-RT RIC terminates the A1 interface to the near-RT RIC. It will also collect OAM data over the O1 interface from the O-RAN nodes.

The O-RAN near-RT RIC 314 is a logical function that enables near-real-time control and optimization of RAN elements and resources via fine-grained data collection and actions over the E2 interface. The near-RT RIC 314 may include one or more AI/ML workflows including model training, inferences, and updates.

The non-RT RIC 312 can be an ML training host to host the training of one or more ML models. ML training can be performed offline using data collected from the RIC, O-DU 315, and O-RU 316. For supervised learning, non-RT RIC 312 is part of the SMO 302, and the ML training host and/or ML model host/actor can be part of the non-RT RIC 312 and/or the near-RT RIC 314. For unsupervised learning, the ML training host and ML model host/actor can be part of the non-RT RIC 312 and/or the near-RT RIC 314. For reinforcement learning, the ML training host and ML model host/actor may be co-located as part of the non-RT RIC 312 and/or the near-RT RIC 314. In some implementations, the non-RT RIC 312 may request or trigger ML model training in the training hosts regardless of where the model is deployed and executed. ML models may be trained and not currently deployed.

The A1 interface is between the non-RT RIC 312 (within or outside the SMO 302) and the near-RT RIC 314. The A1 interface supports three types of services, including a Policy Management Service, an Enrichment Information Service, and an ML Model Management Service.

In some embodiments, an O-RAN network node can include a disaggregated node with at least one O-RAN Radio Unit (O-RU), at least one O-DU coupled via an F1 interface to at least one O-CU coupled via an E2 interface to a RIC (e.g., RIC 312 and/or RIC 314).

As illustrated in FIG. 2 and FIG. 3, key interfaces in O-RAN (e.g., defined and maintained by O-RAN) include the following interfaces: A1, O1, O2, E2, Open Fronthaul M-Plane, and O-Cloud. O-RAN network functions (NFs) can be VNFs, VMs, Containers, and PNFs. Interfaces defined and maintained by 3GPP which are part of the O-RAN architecture include the following interfaces: E1, F1, NG-C, NG-U, X2, Xn, and Uu interfaces.

As illustrated in FIG. 2 and FIG. 3, the following O-RAN control loops may be configured:
(a) Loop-1: (O-DU Scheduler control loop) TTI msec level scheduling;
(b) Loop-2: (Near-RT RIC) 10-500 msec resource optimization; and
(c) Loop-3: (Non-RT RIC) Greater than 500 msec, Policies, Orchestration, and SON.

As illustrated in FIG. 2 and FIG. 3, the following O-RAN nodes may be configured:
(a) O-CU-CP: RRC and PDCP-C NFs (associated with Loop-2);
(b) O-CU-UP: SDAP and PDCP-U NFs (associated with Loop-2);
(c) O-DU: RLC, MAC, and PHY-U NFs (associated with Loop-1); and
(d) O-RU: PHY-L and RF (associated with Loop 1).

As illustrated in FIG. 2 and FIG. 3, the following O-RAN RIC components may be configured:
(a) Non-RT-RIC: Loop 3 RRM services (O1 and A1 interfaces); and
(b) Near-RT-RIC: Loop 2 RRM services (E2 interface).

As illustrated in FIG. 2 and FIG. 3, the following O-RAN interfaces may be configured:
(a) A1 interface is between Non-RT-RIC and the Near-RT RIC functions; A1 is associated with policy guidance for control-plane and user-plane functions; Impacted O-RAN elements associated with A1 include O-RAN nodes, UE groups, and UEs;
(b) O1 interface is between O-RAN Managed Element and the management entity; O1 is associated with Management-plane functions, Configuration, and threshold settings mostly OAM & FCAPS functionality to O-RAN network functions; Impacted O-RAN elements associated with O1 include mostly O-RAN nodes and UE groups (identified e.g. by S-NSSAI and slice ID), sometimes individual UEs (pending solution for UE identifiers);
(c) O2 interface is between the SMO and Infrastructure Management Framework; O2 is associated with the management of Cloud infrastructure and Cloud resources allocated to O-RAN, FCAPS for O-Cloud; Impacted O-RAN elements associated with O2 include O-Cloud, UE groups, and UEs;
(d) E2 interface is between Near-RT RIC and E2 node; E2 is associated with control-plane and user-plane control functions; Impacted O-RAN elements associated with E2 include mostly individual UEs, sometimes UE groups and E2 nodes;
(e) E2-cp is between Near-RT RIC and O-CU-CP functions. E2-up is between Near-RT RIC and O-CU-UP functions;
(f) E2-du is between Near-RT RIC and O-DU functions. E2-en is between Near-RT RIC and O-eNB functions; and
(g) Open Fronthaul Interface is between O-DU and O-RU functions; this interface is associated with CUS (Control User Synchronization) Plane and Management Plane functions and FCAPS to O-RU; Impacted O-RAN elements associated with the Open Fronthaul Interface include O-DU and O-RU functions.

As illustrated in FIG. 1A-FIG. 3, the following 3GPP interfaces may be configured:
(a) E1 interface between the gNB-CU-CP and gNB-CU-UP logical nodes. In O-RAN, it is adopted between the O-CU-CP and the O-CU-UP.
(b) F1 interface between the gNB-CU and gNB-DU logical nodes. In O-RAN, it is adopted between the O-CU and the O-DU. F1-c is between O-CU-CP and O-DU functions. F1-u is between O-CU-UP and O-DU functions.
(c) The NG-U interface is between the gNB-CU-UP and the UPF in the 5GC and is also referred to as N3. In O-RAN, it is adopted between the O-CU-UP and the 5GC.
(d) The X2 interface connects eNBs or connects eNB and en-gNB in EN-DC. In O-RAN, it is adopted for the definition of interoperability profile specifications. X2-c is for the control plane. X2-u for a user plane.
(e) The Xn interface connects gNBs, and ng-eNBs, or connects ng-eNB and gNB. In O-RAN, it is adopted for the definition of interoperability profile specifications. Xn-c is for the control plane. Xn-u is for the user plane.
(f) The UE to e/gNB interface is the Uu interface and is a complete protocol stack from L1 to L3 and terminates in the NG-RAN. Since the Uu messages still flow from the UE to the intended e/gNB managed function, it is not shown in the O-RAN architecture as a separate interface to a specific managed function.

In example embodiments, any of the UEs or RAN network nodes discussed in connection with FIG. 1A-FIG. 3 can be configured to operate using the techniques discussed herein associated with multi-access traffic management in an O-RAN architecture.

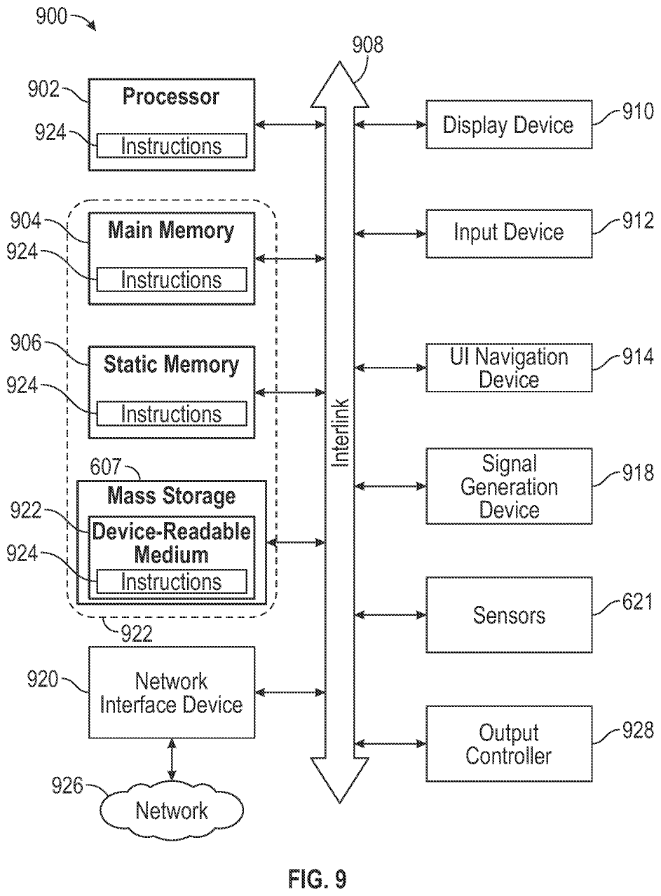

FIG. 9 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects and to perform one or more of the techniques disclosed herein. In alternative aspects, the communication device 900 may operate as a standalone device or may be connected (e.g., networked) to other communication devices.

The communication device may include a hardware processor 902 (e.g., a central processing unit (CPU), a graphics processing unit (GPU), a hardware processor core, or any combination thereof), a main memory 904, a static memory 906, and mass storage 907 (e.g., hard drive, tape drive, flash storage, or other block or storage devices), some or all of which may communicate with each other via an interlink (e.g., bus) 908.

The communication device 900 may further include a display device 910, an alphanumeric input device 912 (e.g., a keyboard), and a user interface (UI) navigation device 914 (e.g., a mouse). In an example, the display device 900, input device 912, and UI navigation device 914 may be a touchscreen display. The communication device 900 may additionally include a signal generation device 918 (e.g., a speaker), a network interface device 920, and one or more sensors 921, such as a global positioning system (GPS) sensor, compass, accelerometer, or another sensor. The communication device 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 907 may include a communication device-readable medium 922, on which is stored one or more sets of data structures or instructions 924 (e.g., software) embodying or utilized by any one or more of the techniques or functions described herein. In some aspects, registers of the processor 902, the main memory 904, the static memory 906, and/or the mass storage 907 may be, or include (completely or at least partially), the device-readable medium 922, on which is stored the one or more sets of data structures or instructions 924, embodying or utilized by any one or more of the techniques or functions described herein. In an example, one or any combination of the hardware processor 902, the main memory 904, the static memory 906, or the mass storage 907 may constitute the device-readable medium 922.

As used herein, the term “device-readable medium” is interchangeable with “computer-readable medium” or “machine-readable medium.” While the communication device-readable medium 922 is illustrated as a single medium, the term “communication device-readable medium” may include a single medium or multiple media (e.g., a centralized or distributed database, and/or associated caches and servers) configured to store the one or more instructions 924. The term “communication device-readable medium” is inclusive of the terms “machine-readable medium” or “computer-readable medium”, and may include any medium that is capable of storing, encoding, or carrying instructions (e.g., instructions 924) for execution by the communication device 900 and that causes the communication device 900 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 924 may further be transmitted or received over a communications network 926 using a transmission medium via the network interface device 920 utilizing any one of several transfer protocols. In an example, the network interface device 920 may include one or more physical jacks (e.g., Ethernet, coaxial, or phone jacks) or one or more antennas to connect to the communications network 626. In an example, the network interface device 920 may include a plurality of antennas to wirelessly communicate using at least one single-input-multiple-output (SIMO), MIMO, or multiple-input-single-output (MISO) techniques. In some examples, the network interface device 920 may wirelessly communicate using Multiple User MIMO techniques.

The term “transmission medium” shall be taken to include any intangible medium that is capable of storing, encoding, or carrying instructions for execution by the communication device 900, and includes digital or analog communications signals or another intangible medium to facilitate communication of such software. In this regard, a transmission medium in the context of this disclosure is a device-readable medium.

Example aspects of the present disclosure are further disclosed hereinbelow.

Example 1 is an apparatus for controlling a node in a wireless communication system, the apparatus comprising: a processor configured to: identify scenarios under which at least one wireless communication system problem can occur, and metrics that characterize the scenarios, to generate a set of sub-problems, a sub-problems of the set corresponding to a respective scenario; identify a set of algorithms for responding to respective sub-problems of the set of sub-problems to generate a module; and provide control logic to determine which algorithm of the module to execute during operation of the wireless communication system based on detection of problems of an identified scenario, and provide identification of a selected algorithm based on the determining; and communication circuitry to provide identification of the selected algorithm for execution within the wireless communication system.

In Example 2, the subject matter of Example 1 can optionally include wherein the module executes within Layer 1, Layer 2 or fronthaul circuitry of the wireless communication system.

In Example 3 the subject matter of Example 2 can optionally include wherein the processor is configured to generate at least two modules.

In Example 4, the subject matter of Example 3 can optionally include wherein one of the at least two modules executes within Layer 1 and the other of the at least two modules executes in Layer 2, and wherein control logic is configured to perform optimization between the at least two modules to select an algorithm for execution and to provide optimized parameters for execution of the selected algorithm.

In Example 5, the subject matter of Example 3 can optionally include wherein each of the at least two modules executes in one of Layer 1, Layer 2 and the fronthaul circuitry, and wherein control logic is configured to perform optimization between the at least two modules to select an algorithm for execution and to provide optimized parameters for execution of the selected algorithm.

In Example 6, the subject matter of any of Examples 1-5 can optionally include wherein at least two modules are generated and wherein the control logic is configured to perform optimization using an artificial intelligence or machine learning mechanism based on metrics identified during execution of the wireless communication system.

In Example 7, the subject matter of any of Examples 1-6 can optionally include wherein control logic is executed in an xApp in a near real time (RT) radio interface controller (RIC).

Example 8 is a device for use in an Open Radio Access Network (O-RAN) base station, the device comprising any of Examples 1-7.

Example 9 is a method for performing any of Examples 1-7.

Although example aspects have been described herein, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus for controlling a node in a wireless communication system, the apparatus comprising:
a processor configured to:
identify scenarios under which at least one wireless communication system problem can occur, and metrics that characterize the scenarios, to generate a set of sub-problems, a sub-problems of the set corresponding to a respective scenario;
identify a set of algorithms for responding to respective sub-problems of the set of sub-problems to generate a module; and
provide control logic to determine which algorithm of the module to execute during operation of the wireless communication system based on detection of problems of an identified scenario, and provide identification of a selected algorithm based on the determining; and
communication circuitry to provide identification of the selected algorithm for execution within the wireless communication system.

2. The apparatus of claim 1, wherein the module executes within Layer 1, Layer 2 or fronthaul circuitry of the wireless communication system.

3. The apparatus of claim 2, wherein the processor is configured to generate at least two modules.

4. The apparatus of claim 3, wherein one of the at least two modules executes within Layer 1 and the other of the at least two modules executes in Layer 2, and wherein control logic is configured to perform optimization between the at least two modules to select an algorithm for execution and to provide optimized parameters for execution of the selected algorithm.

5. The apparatus of claim 3, wherein each of the at least two modules executes in one of Layer 1, Layer 2 and the fronthaul circuitry, and wherein control logic is configured to perform optimization between the at least two modules to select an algorithm for execution and to provide optimized parameters for execution of the selected algorithm.

6. The apparatus of claim 1, wherein at least two modules are generated and wherein the control logic is configured to perform optimization using an artificial intelligence or machine learning mechanism based on metrics identified during execution of the wireless communication system.

7. The apparatus of claim 1, wherein control logic is executed in an xApp in a near real time (RT) radio interface controller (RIC).

8. A device for use in an Open Radio Access Network (O-RAN) base station, the device comprising:
processing circuitry configured to:
identify scenarios under which at least one wireless communication system problem can occur, and metrics that characterize the scenarios, to generate a set of sub-problems, a sub-problem of the set corresponding to a respective scenario;
identify a set of algorithms for responding to respective sub-problems of the set of sub-problems to generate a module; and
provide control logic to determine which algorithm of the module to execute during operation of the wireless communication system based on detection of problems of an identified scenario, and provide identification of a selected algorithm based on the determining;
communication circuitry to provide identification of the selected algorithm for execution within a wireless communication network; and
a memory coupled to the processing circuitry and configured to store metrics for identifying scenarios.

9. The device of claim 8, wherein the module executes within Layer 1, Layer 2 or fronthaul circuitry of the wireless communication system.

10. The device of claim 9, wherein the processing circuitry is configured to generate at least two modules.

11. The device of claim 10, wherein one of the at least two modules executes within Layer 1 and the other of the at least two modules executes in Layer 2, and wherein control logic is configured to perform optimization between the at least two modules to select an algorithm for execution and to provide optimized parameters for execution of the selected algorithm.

12. The device of claim 10, wherein each of the at least two modules executes in one of Layer 1, Layer 2 and the fronthaul circuitry, and wherein control logic is configured to perform optimization between the at least two modules to select an algorithm for execution and to provide optimized parameters for execution of the selected algorithm.

13. The device of claim 8, wherein at least two modules are generated and wherein the control logic is configured to perform optimization using an artificial intelligence or machine learning mechanism based on metrics identified during execution of the wireless communication network.

14. The apparatus of claim 1, wherein control logic is executed in an xApp in a near real time (RT) radio interface controller (RIC).

15. A method for communication in a wireless network, the method comprising:
identifying scenarios under which at least one wireless communication system problem can occur, and metrics that characterize the scenarios, to generate a set of sub-problems, a sub-problem of the set corresponding to a respective scenario;
identifying a set of algorithms for responding to respective sub-problems of the set of sub-problems to generate a module; and
providing control logic to determine which algorithm of the module to execute during operation of the wireless communication system based on detection of problems of an identified scenario, and provide identification of a selected algorithm based on the determining; and
providing identification of the selected algorithm for execution within the wireless communication network.

16. The method of claim 15, wherein the module executes within Layer 1, Layer 2 or fronthaul circuitry of the wireless communication system.

17. The method of claim 16, further comprising generating at least two modules.

18. The method of claim 17, wherein one of the at least two modules executes within Layer 1 and the other of the at least two modules executes in Layer 2, and wherein the method comprises performing optimization between the at least two modules to select an algorithm for execution and to provide optimized parameters for execution of the selected algorithm.

19. The method of claim 17, wherein each of the at least two modules executes in one of Layer 1, Layer 2 and the fronthaul circuitry, and wherein the method comprises performing optimization between the at least two modules to select an algorithm for execution and to provide optimized parameters for execution of the selected algorithm.

20. The method of claim 15, wherein control logic is executed in an xApp in a near real time (RT) radio interface controller (RIC).
